(19) United States
(12) Patent Application Publication
(10) Pub. No.: US 2014/0304058 A1
(43) Pub. Date: Oct. 9, 2014

(54) CLOUD SERVICE AND PRODUCT MANAGEMENT SYSTEM FOR MANAGING WARRANTY AND OTHER PRODUCT INFORMATION

(71) Applicants: Scott Krig, Santa Clara, CA (US); Madan Venugonal, Cupertino, CA (US); Vishwa Hassan, Chandler, AZ (US)

(72) Inventors: Scott Krig, Santa Clara, CA (US); Madan Venugonal, Cupertino, CA (US); Vishwa Hassan, Chandler, AZ (US)

(21) Appl. No.: 13/977,293

(22) PCT Filed: Dec. 27, 2011
(86) PCT No.: PCT/US11/67330

§ 371 Date: Nov. 15, 2013

(51) Int. Cl. G06Q 30/00; G06Q 30/02

(52) U.S. Cl. CPC G06Q 30/012; G06Q 30/0234
USPC 705/14.34; 705/21

(57) ABSTRACT

Disclosed in some examples is a product management service including a point of sale module configured to receive from a point of sale terminal, over a network, product and consumer information as part of a sale of a product described by the product information; associate the consumer information with a consumer account; and update the consumer account with the product information; and a warranty registration module configured to send a portion of the product information and a portion of the customer information to a warranty registration service responsive to updating the consumer account with the product information to register the product described by the product information.

### BACKGROUND

Consumers purchasing products often have obligations to meet in order to take advantage of various aspects of their purchase. For example, consumers must register to receive warranty protection, send in rebate forms, and in other examples, they may have to periodically check various sources to determine information on service, recalls, and updates of the product. With the hundreds of products consumers purchase, these tasks often become unmanageable. The failure to fulfill these obligations may result in losing a warranty, a rebate, or other product benefits.

### BRIEF DESCRIPTION OF THE DRAWINGS

FIG. 1 is a schematic of a system for product management according to some examples of the present disclosure.

FIG. 2 is a flowchart of a method of registering a product with the product management service according to some examples of the present disclosure.

FIG. 3 is a flowchart of a method of determining the warranty information for a product associated with a consumer account according to some examples of the present disclosure.

FIG. 4 is a flowchart of a method of registering the warranty information for a product according to some examples of the present disclosure.

FIG. 5 is a flowchart of a method of registering for a rebate for a product according to some examples of the present disclosure.

FIG. 6 is a flowchart of a method of the product management service getting product updates regarding purchased products according to some examples of the present disclosure.

FIG. 7 is a flowchart of a method of receiving special offers according to some examples of the present disclosure.

FIG. 8 is a schematic of a product management service according to some examples of the present disclosure.

FIG. 9 is a schematic of a machine in the example form of a computer system according to some examples of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Disclosed in some examples is a product management service that receives information on products purchased by consumers and associates that information with a consumer account. The product management service may automatically manage any consumer obligation with respect to the product. Such obligations may include registering and managing the warranty of the product; applying for and managing the status of any rebates or promotions associated with the purchase of the product; and tracking and managing product updates, product service, or recall information associated with the product.

This process may be started at the point of sale (POS) where a store employee may enter product information and/or consumer information. This information may then be sent to a product management service over a network. The product management service may then automatically contact a number of internal or external data sources to register the product to the consumer, obtain warranty information (for display to a consumer), register for rebates, register for notifications on product updates or recalls, contact the consumer regarding the product, and the like.

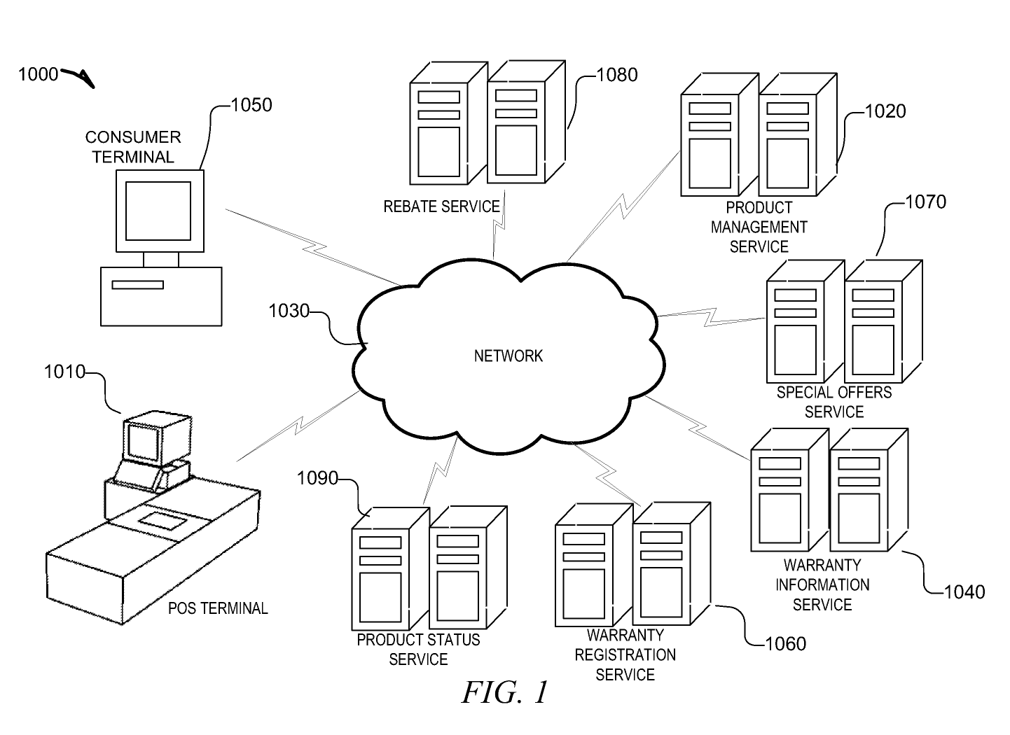

Turning now to FIG. 1, a system for product management 1000 is shown. Point of sale (POS) terminal 1010 may be used by employees of a merchant for completing purchasing transactions and may include equipment for entering product information, totaling purchases made, processing payments and the like. Such POS equipment may include a cash register, bar code readers, manual entry equipment (e.g., keyboards), display devices, cash drawers, check processing equipment, or credit card processing equipment. POS terminal 1010 may be located at a brick and mortar merchant location, an online shopping service, or the like. POS terminal 1010 may also include communications equipment to communicate with a product management service 1020 over network 1030. POS terminal 1010 may send product information as well as consumer information to product management service 1020.

Product information may be any information which may be used to uniquely identify the type of product and in some examples the information may also include information which may be used to uniquely identify a specific unit, or a group of specific units, of that type of product. The identification of the type of product may include a universal product code (UPC code), a stock-keeping unit (SKU) an item description (e.g., manufacturer and model number), or the like. The information identifying a specific unit, or group of units, of that type of product may include a serial number, a lot number, a batch number, a manufacture date, or the like.

Consumer information may include credit card information, name, address, product management service account information (e.g., username, a password, a pin number), or any other information which may be used by the product management service to associate the customer with an account on the product management service. The consumer information may be entered into POS terminal 1010 by scanning a bar code on the product using a bar code reader, manually entering a SKU or UPC code into a keyboard or touch screen display, reading an Radio Frequency Identification (RFID) tag embedded in the product, or the like. Likewise, the consumer information may be entered into POS terminal 1010 by using the credit card processing equipment, entering personal details into a keyboard or touch screen, an RFID tag worn or carried by the consumer, scanning a driver's license or the like.

Product management service 1020 may receive the product and consumer information from POS terminal 1010 and may associate the product information with a consumer account on the product management service 1020. In some examples, the consumer may have created an account prior to the purchase and thus the consumer information may be used to link a previously created account with a new purchase. In other examples, the consumer information may be stored for later account creation. For example, a list of product purchases along with credit card information may be stored. Later, a consumer may open an account with product management service 1020 and associate various credit card information with the account. Product management service 1020 may then search its stored transactions to associate past purchased products with the new consumer account based on the credit card information. In yet other examples, product management service 1020 may assign a unique identifier to the transaction and send the unique id back to POS terminal 1010 which may pass this on to the consumer who may login to product management service 1020 and create an account based on the unique identifier. In still other examples, POS terminal 1010 may allow the consumer to enter information to create an account at POS terminal 1010.

Product management service 1020 may provide a web-based user interface so that a consumer may use consumer terminal 1050 to access and manage information on products they own, add new products to be managed, update their accounts and contact information, view notices regarding products they own, receive special offers, update warranty information, update registration status, and the like.

Once a product is associated with a consumer account, product management service 1020 may then contact external data sources to ascertain information on the product and its warranty as well as to fulfill the obligations of the consumer to realize the manufacturer and merchant's offered benefits (e.g., warranty, rebates, or the like) for that product. While in FIG. 1, these data sources are shown as separate data sources, it will be appreciated by those skilled in the art with the benefit of Applicants' disclosure that the functionality provided by any of these data services may be provided by a single data service, or by two or more data services.

Product management service 1020 may contact warranty information service 1040 to obtain information regarding the terms of the product's warranty. Warranty information service 1040 may be any data source that provides warranty information about a particular product. Warranty information service 1040 may be setup and managed by the manufacturer of the product, the merchant, or a third party. In some examples warranty information service may be a dedicated service which responds to queries regarding warranty information for products. The service may communicate with the product management service over an agreed-to protocol. For example, the product management service 1020 may provide product information to the warranty information service 1040 and receive warranty details in response.

While a warranty information service 1040 may be consulted to ascertain warranty information, in yet other examples, other data sources may be utilized. For example, a merchant may list warranty information in conjunction with product information for products sold on their site. Product management service 1020 may scrape the merchant's commerce site for warranty information using one or more text matching or recognition algorithms to determine warranty information. In another example, POS terminal 1010 may send warranty information entered by the employee or consumer from information on the product's packaging or manuals. In some other examples, warranty information may be entered by the consumer through consumer terminal 1050. In still other examples, product management service 1020 may provide an interface for manufacturers or merchants with which they can login and provide warranty information for various products. In some examples, this interface may include a web-based interface, such as a web-site. The entered information may be stored by product management service 1020 along with the product information. Once warranty information for a particular product has been determined, the product management service 1020 may not have to determine the warranty information for other products of the same type registered to any consumer.

Product management service 1020 may also contact a warranty registration service 1060 to register the product for the consumer. Warranty registration service 1060 may be any service accessible by product management service 1020 which may accept product registration requests for products. Warranty registration service 1060 may be setup and run by a merchant, a manufacturer, or a third party. The service may communicate with the product management service over an agreed-to protocol. For example, product management service 1020 may provide registration information (e.g., product information and consumer information) and receive a confirmation in response.

While warranty registration service 1060 may be used in some examples, in other examples, the product management service 1020 may send registration information via email, by regular mail, or the like to merchants or manufacturers. In yet other examples, the product management service 1020 may provide an interface for employees of the merchant or manufacturer which may allow these employees to login and to set registration requirements (e.g., what data is needed to complete a registration), see product registrations, and to see information regarding those product registrations. In these examples, product management service 1020 may automatically register the consumer's warranty upon associating the product with the consumer's account if product management service 1020 has enough information to register specified by the manufacturer. If product management service 1020 does not have all the required information, it may notify the consumer to supply the additional required information to complete the registration process.

Product management service 1020 may also receive special offers related to the product from special offers service 1070. Special offers may be any discount, promotion, or other offering based upon a consumer's personal information or purchase histories. Special offers may also include promotional offers made to the general public. Special offers service 1070 may be any data source that provides information on, or issues special offers in conjunction with products. Special offers service 1070 may be setup and managed by a merchant, a manufacturer, or a third party. In some examples the warranty information service 1040 may be a dedicated service that responds to queries about special offers, or notifies product management service 1020 of special offers. The product management service 1020 may communicate with the product management service over an agreed-to protocol. For example, the product management service 1020 may provide information regarding products a consumer owns to special offers service 1070, which may reply with any special offers based on those products. In other examples, special offer service 1070 may send special offers to product management service 1020, which may determine which consumer accounts match the terms in the special offer. These consumers may then be contacted about the special offer (subject to privacy controls). In some examples, product management service 1020 may register with special offers service 1070 to receive notifications of future special offers.

While special offer service 1070 may be used in some examples, in other examples, product management service 1020 may provide an interface for employees of the merchant or manufacturer which may allow these employees to login and to setup special offers. In these examples, product management service 1020 may automatically determine the applicability of a merchant's or manufacturer's special offers to a consumer based upon purchases and other personal data and may automatically notify the consumer of these special offers.

Product management service 1020 may also contact rebate service 1080. In some examples the rebate service 1080 may be any service which may accept rebate applications and initiate processing of rebates. The rebate service 1080 may be run by a merchant, a manufacturer, or a third party. In some examples, rebate service 1080 may be a dedicated service which accepts rebate applications and responds with a confirmation that the application was accepted. The product management service 1020 may communicate with the product management service 1020 over an agreed-to protocol. For example, product management service 1020 may provide rebate information (e.g., product information and/or consumer information) to rebate service in order to register for rebates. In some examples, rebate service 1080 may also allow product management service 1020 to check to see if a rebate exists for the product. In other examples, rebate service 1080 may allow for rebate status inquiries to determine the current status of the rebate (e.g., still process, paid, etc.). Product management service 1020 may utilize this functionality to check and update the status of available rebates after the application is submitted periodically so that the consumer does not need to follow up with the manufacturer or retailer. In some examples product management service 1020 may check on the status at specific time intervals (e.g., every week, month, etc.). In some examples, rebate service 1080 may notify product management service 1020 of missing or incomplete information in the rebate application. Product management service 1020 may send the missing information to the rebate service 1080 if the information is available, or, the product management service 1020 may notify the consumer that the application cannot be completed and prompt the consumer to enter the additional information.

While a rebate service 1080 may be used in some examples, in other examples, the product management service 1020 may provide an interface for employees of the merchant or manufacturer through which they can setup rebates, receive notifications of rebate applications, and process rebates. In these examples the product management service 1020 may automatically determine the applicability of various rebates and apply for those rebates. If additional information is required to apply for a particular rebate the consumer may be notified that additional information is required. In some examples, the rebates may be automatically deducted from a bank account associated with a merchant and issued to the consumer. In some examples the issuance to the consumer may include a credit issued to a credit card associated with the consumer's account, a check, a direct deposit into a bank account associated with the consumer and the like. In other examples, product management service 1020 may fill out rebate forms and automatically mail them, email them, or the like. The rebate forms may be determined from the consumer, a merchant, or an external website (which may be scraped to determine what information is required to obtain the rebate and where to send the information). A rebate may be any reimbursement of the consumer for a portion (or all) of the purchase price of a product upon purchase of that product and submission of certain information.

Product management service 1020 may register with, or periodically contact product status service 1090 to get updates and information on the status of products. Product status information may be information about the product which may affect the safety or functionality of the product. Product status service 1090 may be any data source which may provide product status information about one or more products. Example product status information may include recalls, service information, software upgrades, or the like. Product status service 1090 may be run by a merchant, a manufacturer, or a third party. In some examples, product status service 1090 may be a dedicated service which responds to queries about the status of products or notifies product management service 1020 of changes in product status. Product status service 1090 may communicate with the product management service over an agreed-to protocol. For example, the product management service 1020 may periodically request status information about a product from product status service 1090. Product status service 1090 may reply with the current product status. In other examples, product management service 1020 may register to receive automatic notifications from product status service 1090 regarding changes in product status information for products associated with consumer accounts. Product management service 1020 may then notify the consumer about changes to the status of products associated with that consumer.

While product status service 1090 may be used in some examples, in other examples, product status service 1090 may be a site provided by a third party, for example, the Consumer Product Safety Commission which posts notices on safety recalls. In this example, product management service 1020 may scrape the site for product status information using one or more text matching or recognition algorithms to determine product status information. In yet other examples, product management service 1020 may provide an interface to allow a merchant or manufacturer to enter and manage product status information on the product management service 1020. The product management service 1020 may then automatically determine the consumers affected by a change in product status entered by the manufacturer or merchant and notify them appropriately.

The user may be notified about the progress of any of the above steps through one or more notification mechanisms. Notification mechanisms may include notifications displayed to users when they login to their product management service account, emails, text messages, automated phone calls, or the like.

In some examples, the various component services may communicate using one or more standards. For example, the components may utilize Simple Object Access Protocol (SOAP) which is a protocol specification for exchanging structured information in the implementation of web services in computer networks. SOAP relies upon Extensible Markup Language (XML) for its message format, and relies on other Application Layer protocols (e.g., HyperTextTransfer Protocol—HTTP or Simple Mail Transfer Protocol SMTP). In addition, because personal data may be sent over unprotected networks, various security protocols may be utilized, such as for example, the Advanced Encryption Standard (AES), which is a symmetric-key algorithm, or Pretty Good Privacy (PGP), or the like.

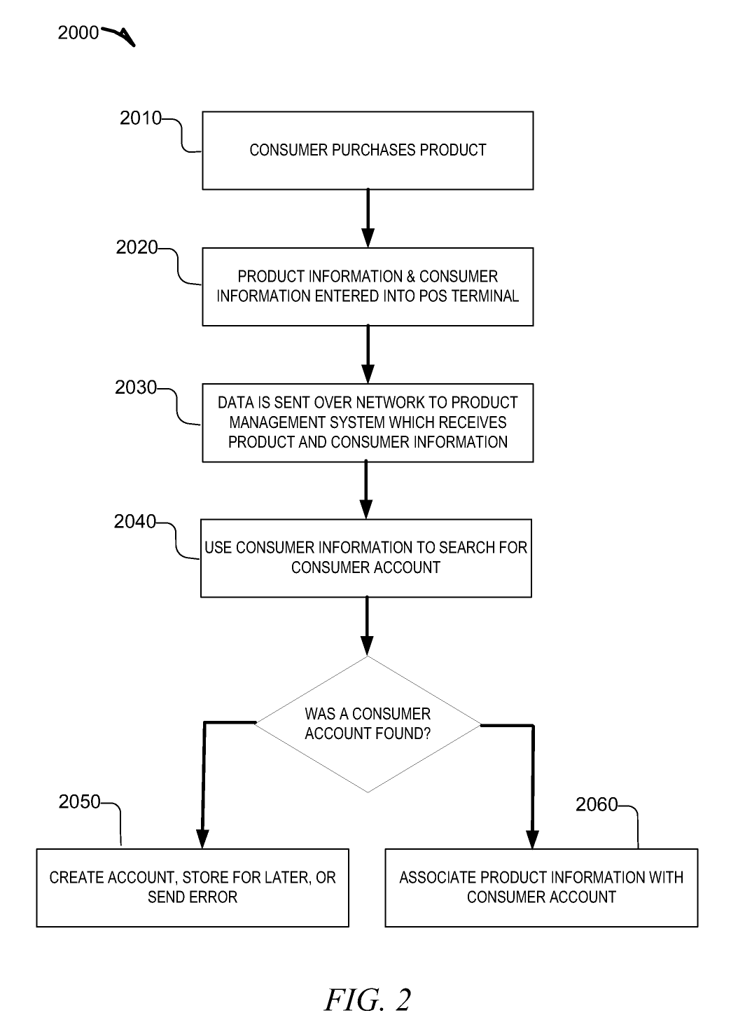

A flowchart of an example method 2000 of registering a product with the product management service is shown in FIG. 2. At operation 2010, the consumer purchases a product. At operation 2020 the product information and consumer information is entered into a POS terminal. For example, the cashier may scan the UPC code of the product and a serial number of the product. The cashier may also collect consumer information, such as credit card number, name, address, or the like. At operation 2030, the product and consumer information may be sent to the product management service. In some examples, this information may be sent using secure mechanisms to prevent others from accessing the information. For example, the POS terminal may utilize secure socket layer (SSL) protocols to secure the connection over the network with the product management service. At operation 2040, the product management service may use the consumer information to search its account records to find the consumer's account. At decision block 245, it is determined whether the consumer account was found. If an account is not found that matches the consumer information, the system may create an account, store the product information and consumer information for later (e.g., store the credit card and product information for later association with a later created account) or may inform the POS terminal that an account could not be found at operation 2050. In some examples, the POS terminal may send additional or updated consumer information (e.g., perhaps the consumer incorrectly entered the information). If the account is found, the product information is associated with the consumer's account at operation 2060. In some examples the product management service may inform the POS terminal of whether an account was created, or whether the product was associated successfully with an existing account or the like.

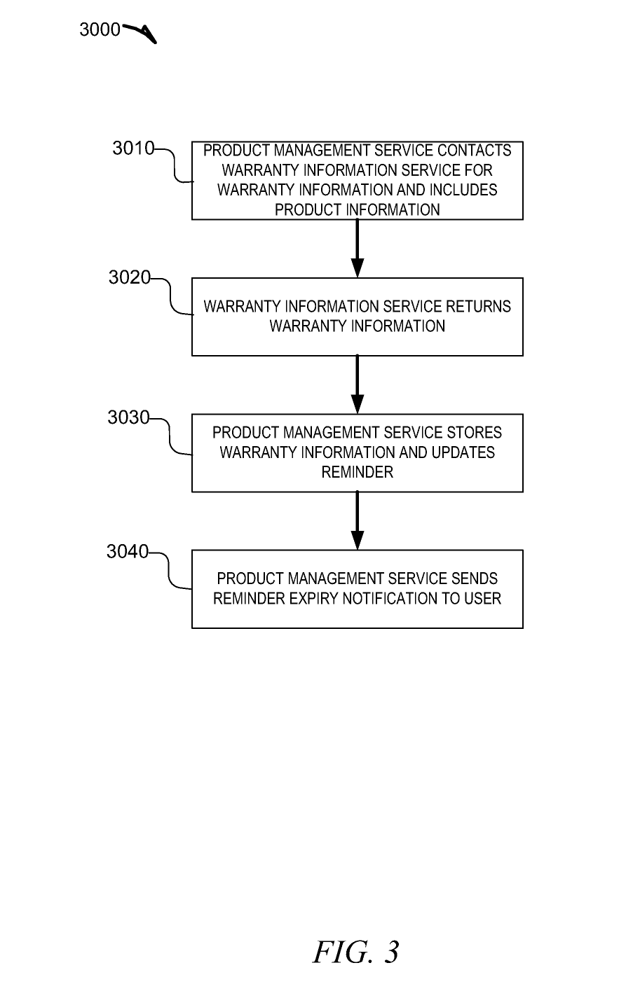

A flowchart of an example method 3000 of determining the warranty information for a product associated with a consumer account is shown in FIG. 3. At operation 3010 the product management service may contact a warranty information service for warranty information. The product management service may include product information to specify which product the product management service is inquiring about. At operation 3020 the product management service may receive the warranty information from the warranty information service. At operation 3030, the product management service may store the warranty information and set various warranty reminders. At the expiry of these reminders, the consumer is notified that the reminder has expired and that they may wish to take some action. For example, the product management service may set a reminder to notify the consumer prior to warranty expiry. The reminder may be used to inform the user that they should consider an extended warranty, or to ensure they have any warranty service performed prior to the expiration of the warranty. At operation 3040, the product management service sends the reminder expiry notification to the user.

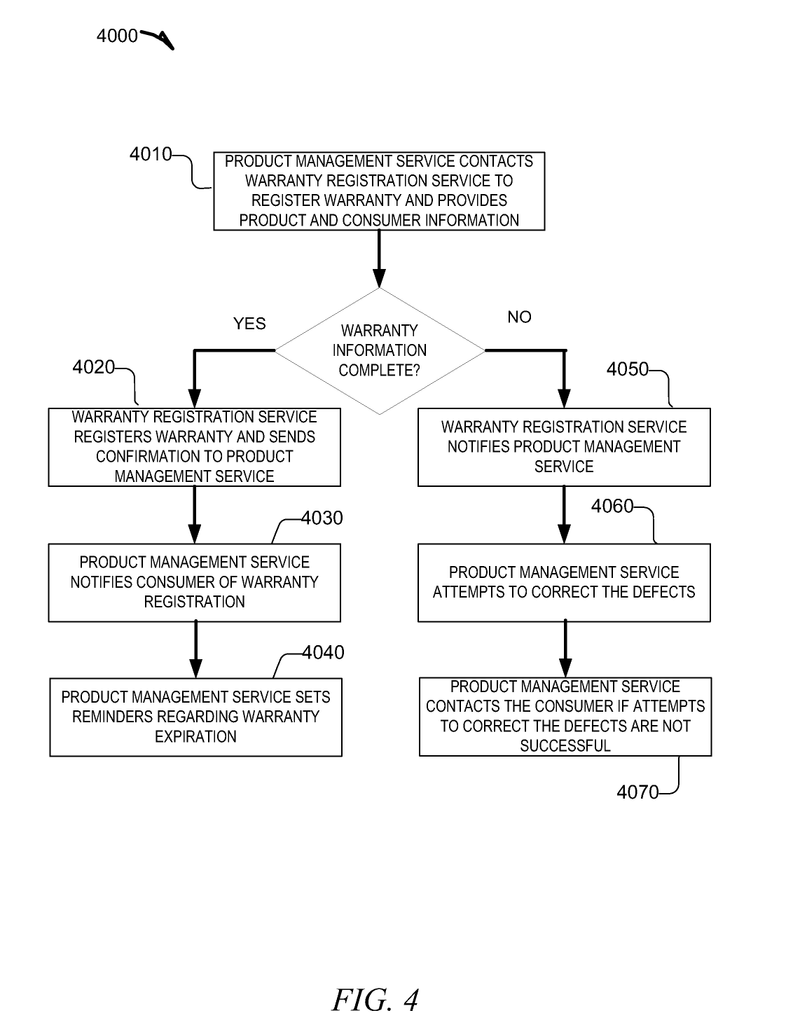

A flowchart of an example method 4000 of registering the warranty information for a product is shown in FIG. 4. At operation 4010, the product management service contacts a warranty registration service to register the warranty. The product management service may send warranty registration information to the warranty registration service which may include information on the product, the consumer, or the like depending on the registration requirements. In some examples, the warranty registration service and the product management service operate under an agreed-to transaction protocol and thus the information required to register a warranty may be determined in advance. In other examples, the product management service may request the requirements prior to sending any information. If the warranty registration information meets the requirements to register the warranty, at operation 4020. the warranty registration service registers the warranty and sends a confirmation to product management service. At operation 4030. the product management service may notify the customer of the warranty registration. At operation 4040, the product management service may set a number of reminders regarding the warranty expiration if those reminders were not already set when obtaining the warranty information. If the warranty information sent is not complete, the warranty registration service may notify the product management service at operation 4050. In some examples, it may be possible for the product management service to send additional information which may complete the registration process. At operation 4060. if it is possible to send additional information, the product management service sends any additional information in an attempt to cure the defects with the registration. At operation 4070, if this proves unsuccessful, the consumer is notified of the failure to register the warranty. If the defects in the registration are corrected, operations 4020-4040 are performed.

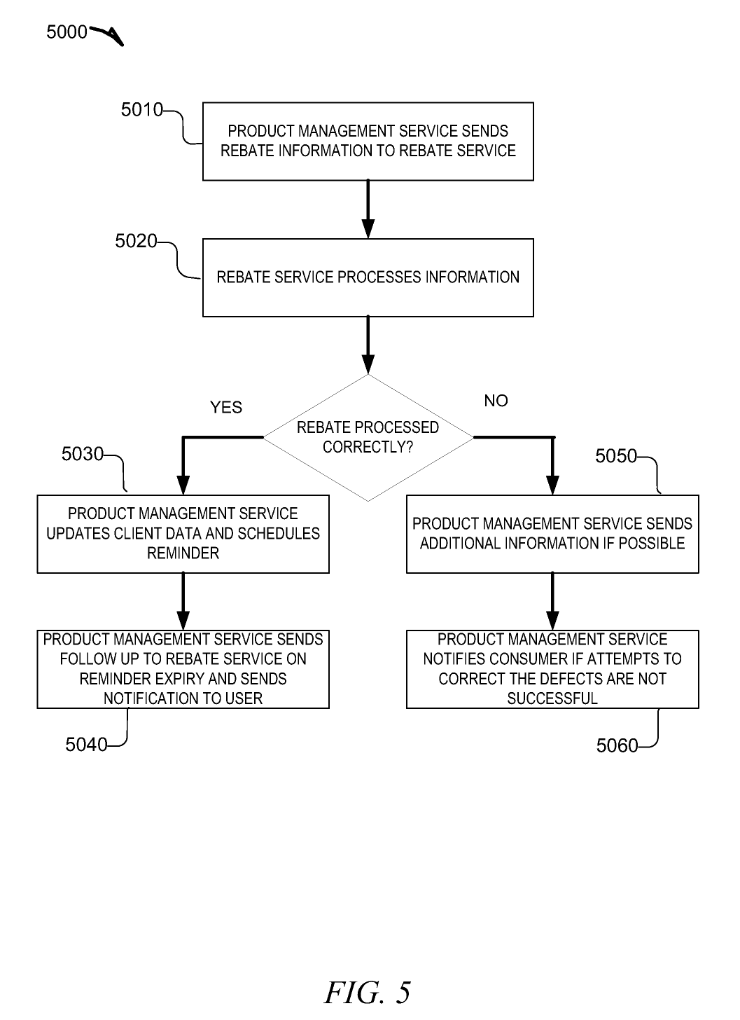

A flowchart of an example method 5000 of registering for a rebate for a product is shown in FIG. 5. At operation 5010, the product management service sends rebate information to the rebate service. In some examples, the rebate service and the product management service operate under an agreed-to transaction protocol and thus the information required to apply for a rebate may be determined in advance. In other examples, the product management service may request the requirements prior to sending any information. The rebate information may include portions of the consumer and/or product information. At operation 5020, the product management service may receive an indication of whether or not the rebate was processed successfully. If the rebate service indicates that the rebate application is complete, the product management service notes the pending rebate in the consumer's account information and may set a follow up reminder at operation 5030. The follow up reminder may be used to check the status of the rebate to make sure it was properly processed and paid. At operation 5040, upon expiry of the reminder, the product management service may send a follow up to the rebate service to determine the current status of the rebate and/or may notify the consumer so that the consumer may follow up. If the rebate information was not complete, the product management service may send any additional information necessary to process the rebate at operation 5050. In some examples, the product management service may not be able to supply the missing information. In this example, the product management service may notify the consumer at operation 5060.

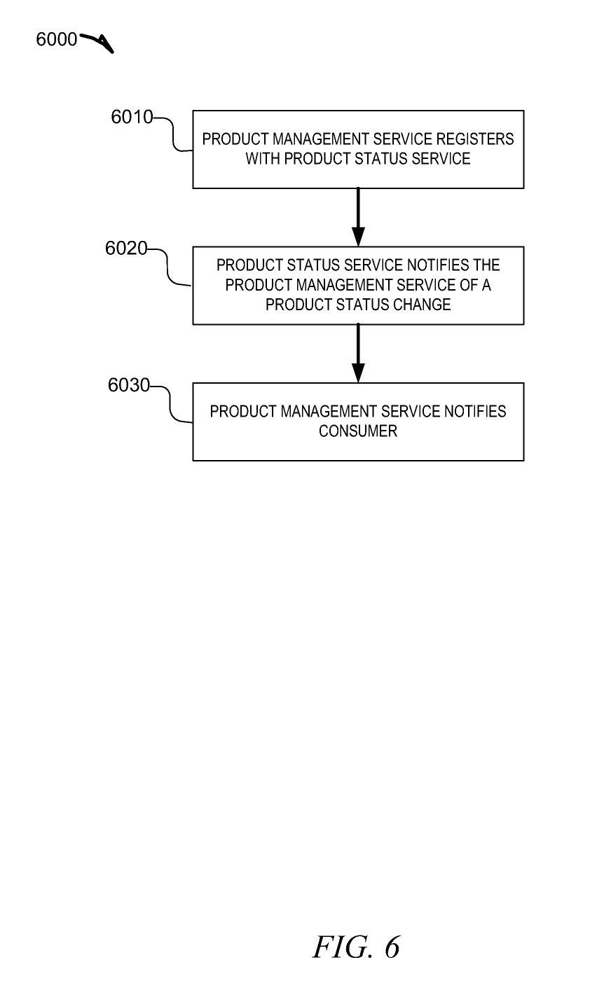

A flowchart of an example method 6000 of the product management service getting product updates regarding purchased products is shown in FIG. 6. At operation 6010, the project management service may register with a product status service, in order to receive notifications about products associated with consumers having an account with the product management service. The product status service provides notifications on the status of products. The status of a product includes any information a product which relates to its safety or functionality. In some examples, this may include recall notices, software update notices, service notices. or the like. At operation 6020, the product status service may notify the product management service of a status update regarding one of the registered products. At operation 6030, the product management service notifies the consumers of the status update if the product associated with the status update is associated with the consumer's account. While the method shown utilizes a registration process, the product management service may also periodically check the product status service or other sites (such as the site of the Consumer Product Safety Commission) for recalls, product updates, and the like.

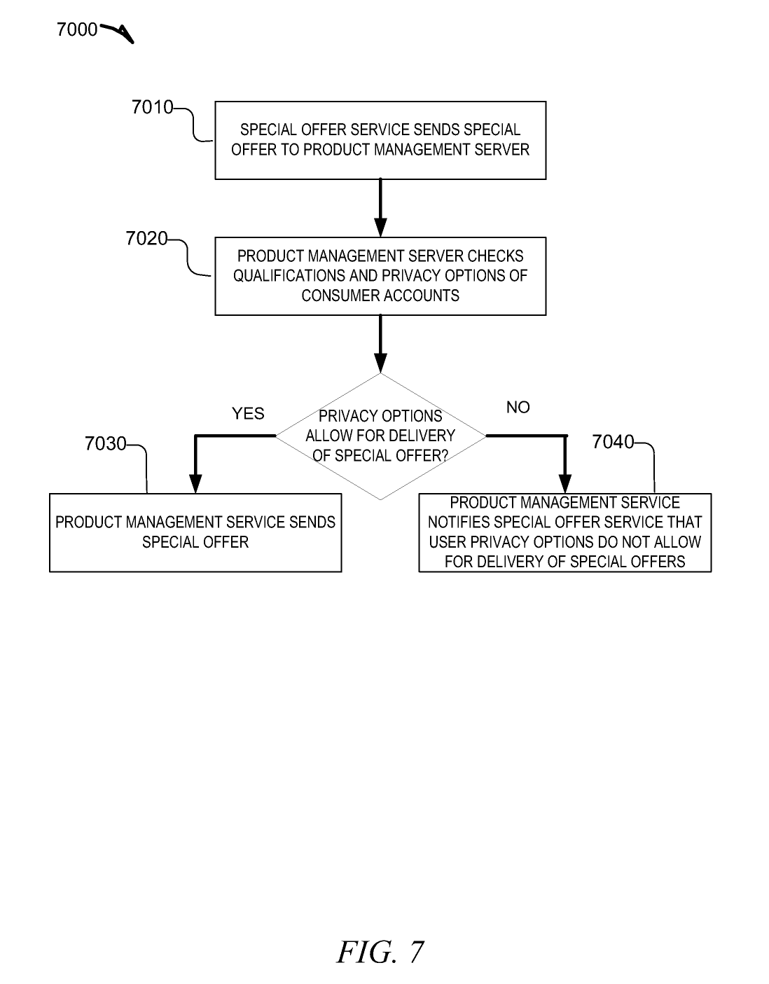

A flowchart of an example method 7000 of receiving special offers is shown in FIG. 7. At operation 7010, a special offer service may send special offers to the product management service. These offers may be based upon the products a consumer is associated with on the product management service. In some examples, the product management service may inform the special offer service of the various products which the consumer owns to allow the special offer service to tailor special offers to consumers. At operation 7020, the product management service may check the requirements of the special offer against the qualifications and privacy options of the various consumer accounts. If the qualifications and privacy options allow for delivery of the special offer, at operation 7030, the product management service may send the special offer to the consumer. Otherwise, the product management service may notify the manufacturer that the consumer's privacy options or qualifications do not allow for delivery of special offers at operation 7040. Qualifications may include one or more requirements which are specified by the special offer service in order for the consumer to qualify for the special offer. Examples may include owning certain products or combinations of certain products, specific demographic data, combinations of product ownership and demographic data, and the like.

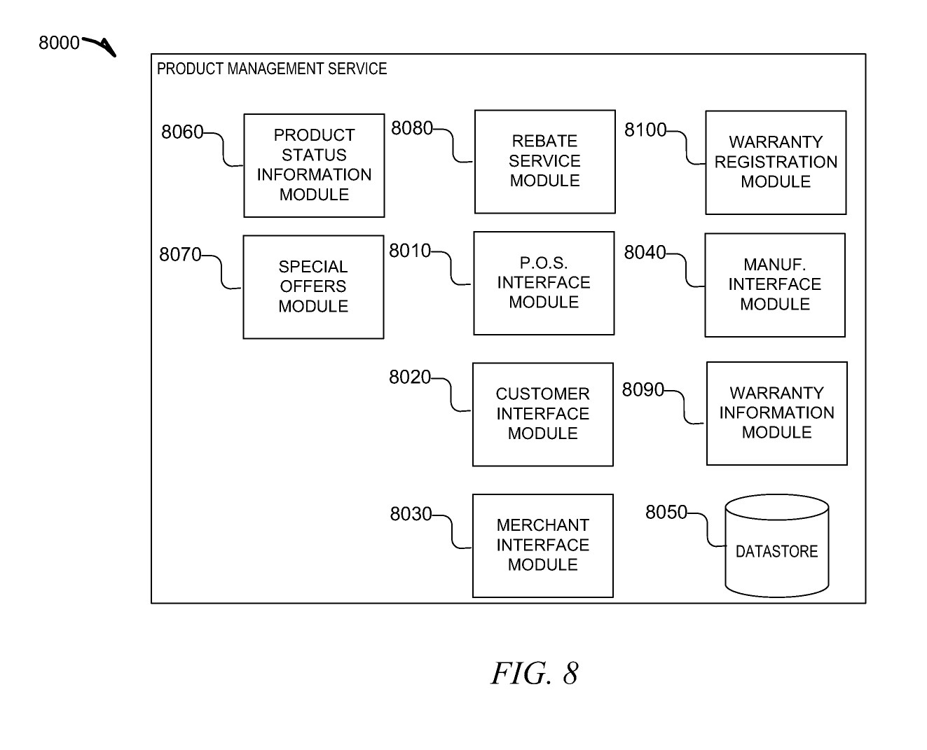

Example components of product management service 8000 are shown in FIG. 8. POS interface module 8010 communicates over a network with one or more POS devices and receives product and consumer information, and in some examples associates the product information with a consumer account identified by the consumer information. A consumer account may include information that the product management service has collected regarding the consumer including products purchased, demographic information, payment information, preferences, and the like.

Customer interface module 8020 provides an interface, accessible over a network (such as portions of the Internet), by consumers who may login, view products associated with their accounts, add new products (e.g., products purchased from retailers who do not support the system), check on product notifications, rebate status, product status and the like.

Merchant interface module 8030 provides an interface, accessible over a network (such as portions of the Internet), by merchants who may login, submit product information (e.g., warranty information), special offers, or the like.

Manufacturer interface module 8040 provides an interface, accessible over a network (such as portions of the Internet), by manufacturers who may login, submit product information (e.g., warranty information), process warranty claims, process rebates, process special offers, or the like. In some examples these interfaces may be accessible by merchants, consumers, manufacturers, or the like across a network (e.g., the Internet). For example, the interface may be web-browser based and may include one or more markup components (e.g., HyperText Markup Language, eXtensible Markup Language, or the like), various scripting components (e.g., JavaScript, or the like), or the like. Some of these components may be executable on the computing device used by the merchants, consumers, manufacturers or the like to access the interfaces.

Datastore 8050 may store the consumer accounts and the associated products, their statuses, rebate status information, warranty information, scheduled reminders and the like.

Product status information module 8060 may contact a product status service and update information on the status of various products stored in datastore 8050.

Special offers module 8070 may receive or obtain special offers from one or more special offers services and may notify consumers of special offers to which they are entitled.

Rebate service module 8080 may receive information on and apply for rebates offered by a rebate service. Rebate service module 8080 may utilize the consumer and/or product information in datastore 8050 to apply for rebates on behalf of the consumer. Warranty information module 8090 may interface with a warranty information service to ascertain product warranty information and update that information in datastore 8050. Warranty registration module 8100 may utilize the stored product and consumer information in order to register a warranty with a warranty registration service.

In some examples, the product management service 1020 may charge users of the system a fee to use the system. In other examples, manufacturers or retails may be charged to participate in the system. In still yet other examples, point of sale terminal device manufacturers may be charged to interface with the system. In other examples, the retailers (online, or stores) who utilize this service may be charged. In yet other examples, affiliate advertisements may be sold (e.g., special offer providers). These payments may be based on time (e.g., a monthly fee), usage (e.g., the number of products registered, the number of special offers delivered), a one time fee, or any other arrangement. The payments may be processed by the product management service 1020 based on billing records kept by the product management service 1020 and may be made by credit card charge, direct withdrawal, paper billing, e-billing, or the like.

Method steps described herein may be performed automatically by product management service 1020. For example, the product management service 1020 may automatically register the product, get warranty information, register for a rebate, check for product status information, and receive, or register for special offers upon the occurrence of one or more events, such as the registration of a new product, addition of missing information to the consumer's account, consumer authorization, or the like.

### Modules, Components and Logic

Certain embodiments are described herein as including logic or a number of components, modules, or mechanisms. Modules or components may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors, including processor, may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as services or “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Implementation

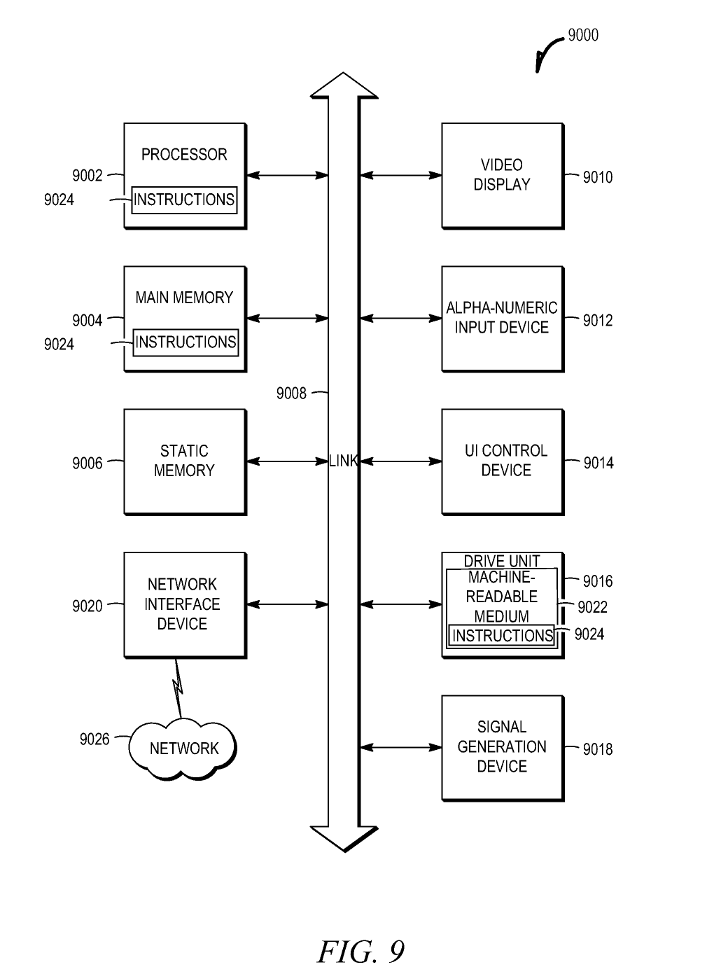

FIG. 9 shows a diagrammatic representation of a machine in the example form of a computer system 9000 within which a set of instructions for causing the machine to perform any one or more of the methods, processes, operations, or methodologies discussed herein may be executed. In some examples the various services, computer terminals, POS terminals, and the like may be or include portions or all of the computer system 9000. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 9000 includes a processor 9002 (e.g., a Central Processing Unit (CPU), a Graphics Processing Unit (GPU) or both, or processor core, compute node), a main memory 9004 and a static memory 9006, which communicate with each other via a link 9008. The computer system 9000 may further include a video display unit 9010 (e.g., a Liquid Crystal Display (LCD) or a Cathode Ray Tube (CRT)). The computer system 9000 also includes an alphanumeric input device 9012 (e.g., a keyboard), a User Interface (UI) controller 9014 (e.g., a mouse), a disk drive unit 9016, a signal generation device 9018 (e.g., a speaker) and a network interface device 9020 (e.g., a transmitter).

The disk drive unit 9016 includes at least one machine-readable medium 9022 on which is stored one or more sets of instructions 9024 and data structures (e.g., software) embodying or used by any one or more of the methodologies or functions illustrated herein. The instructions 9024 may also reside, completely or at least partially, within the main memory 9004 and/or within the processor 9002 during execution thereof by the computer system 9000, with the main memory 9004 and the processor 9002 also constituting machine-readable media.

The instructions 9024 may further be transmitted or received over a network 9026 via the network interface device 9020 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### Other Notes and Examples

### Example 1

A system for providing a product management service, the system comprising: a point of sale interface module configured to: receive from a point of sale terminal, over a network, product and consumer information as part of a sale of a product described by the product information; associate the consumer information with a consumer account; and update the consumer account with the product information responsive to associating the consumer information with a consumer account using a computer processor; and a warranty registration module configured to send a portion of the product information and a portion of the customer information to a warranty registration service responsive to updating the consumer account with the product information to register the product described by the product information.

### Example 2

The system of example 1, comprising a rebate module configured to determine that a rebate is applicable to the product information and responsive to determining that the rebate is applicable to the product information, sending a portion of the product information and a portion of the customer information to a rebate service to apply for the rebate.

### Example 3

The system of example 2, wherein the rebate module is configured to receive a confirmation from the rebate service that the rebate was processed successfully.

### Example 4

The system of example 3, wherein the rebate module is configured to set a follow-up reminder responsive to receiving the confirmation from the rebate service.

### Example 5

The system of example 4, wherein the rebate module is configured to check a status of the rebate on expiry of the follow-up reminder.

### Example 6

The system of example 5, wherein the rebate module is configured to notify a consumer associated with the consumer account responsive to checking the status of the rebate.

### Example 7

The system of any one of the previous examples, comprising a consumer interface module configured to provide a consumer with a network accessible user interface, which allows the consumer to view information related to their consumer account.

### Example 8

The system of any one of the previous examples, wherein the point of sale interface module and the point of sale terminal communicate using a secure protocol.

### Example 9

The system of any one of the previous examples, wherein the product information comprises at least one of: a universal product code, a stock keeping unit, an item description, a serial number, a lot number, a batch number, and a manufacture date.

### Example 10

The system of any one of the previous examples, wherein the consumer information includes at least one of: credit card information, name, address, account information for an account on the product management service.

### Example 11

A computer processor implemented method of product management comprising: receiving from a point of sale terminal, over a network, by a product management service, product and consumer information as part of a sale of a product described by the product information; associating the consumer information with a consumer account by the product management service using the computer processor; automatically updating the consumer account with the product information responsive to associating the consumer information with a consumer account by the product management service; sending a portion of the product information and a portion of the customer information by the product management service, to a warranty registration service responsive to updating the consumer account with the product information to register the product described by the product information.

### Example 12

The method of example 11, comprising: determining that a rebate is applicable to the product information; and responsive to determining that the rebate is applicable to the product information, sending a portion of the product information and a portion of the customer information to a rebate service to apply for the rebate.

### Example 13

The method of example 12, comprising receiving a confirmation from the rebate service that the rebate was processed successfully.

### Example 14

The method of example 13, comprising setting a follow-up reminder responsive to receiving the confirmation from the rebate service.

### Example 15

The method of example 14, comprising checking a status of the rebate on expiry of the follow-up reminder.

### Example 16

The method of example 15, comprising notifying a consumer associated with the consumer account responsive to checking the status of the rebate.

### Example 17

The method of any one of the previous examples, comprising providing a consumer with a network accessible user interface, which allows the consumer to view information related to their consumer account.

### Example 18

The method of any one of the previous examples, wherein receiving from a point of sale terminal, over a network, by a product management service, product and consumer information as part of a sale of a product described by the product information is done using a secure protocol.

### Example 19

The method of any one of the previous examples, wherein the product information comprises at least one of: a universal product code, a stock keeping unit, an item description, a serial number, a lot number, a batch number, and a manufacture date.

### Example 20

The method of any one of the previous examples, wherein the consumer information includes at least one of: credit card information, name, address, account information for an account on the product management service.

### Example 21

At least one machine readable medium storing instructions which when performed by a machine, cause the machine to perform operations comprising: receiving from a point of sale terminal, over a network, product and consumer information as part of a sale of a product described by the product information; associating the consumer information with a consumer account; updating the consumer account with the product information responsive to associating the consumer information with a consumer account; sending a portion of the product information and a portion of the customer information to a warranty registration service responsive to updating the consumer account with the product information to register the product described by the product information.

### Example 22

The machine-readable medium of example 21, wherein the instructions which when performed by the machine, cause the machine to perform operations comprising: determining that a rebate is applicable to the product information and responsive to determining that the rebate is applicable to the product information, sending a portion of the product information and a portion of the customer information to a rebate service to apply for the rebate.

### Example 23

The machine-readable medium of example 22, wherein the instructions which when performed by the machine, cause the machine to perform operations comprising: receiving a confirmation from the rebate service that the rebate was processed successfully.

### Example 24

The machine-readable medium of example 23, wherein the instructions which when performed by the machine, cause the machine to perform operations comprising: setting a follow-up reminder responsive to receiving the confirmation from the rebate service.

### Example 25

The machine-readable medium of example 24, wherein the instructions which when performed by the machine, cause the machine to perform operations comprising: checking a status of the rebate on expiry of the follow-up reminder.

### Example 26

The machine-readable medium of example 25, wherein the instructions which when performed by the machine, cause the machine to perform operations comprising: notifying a consumer associated with the consumer account responsive to checking the status of the rebate.

### Example 27

The machine-readable medium of any one of the previous claims, wherein the instructions which when performed by the machine, cause the machine to perform operations comprising: providing a consumer with a network accessible user interface, which allows the consumer to view information related to their consumer account.

### Example 28

The machine-readable medium of any one of the previous examples, wherein the instructions for receiving from a point of sale terminal, over a network, by a product management service, product and consumer information as part of a sale of a product described by the product information include instructions which when performed by the machine, cause the machine to perform operations comprising: communicating with the point of sale terminal using a secure protocol.

### Example 29

The machine-readable medium of any one of the previous examples, wherein the product information comprises at least one of: a universal product code, a stock keeping unit, an item description, a serial number, a lot number, a batch number, and a manufacture date.

### Example 30

The machine-readable medium of any one of the previous examples, wherein the consumer information includes at least one of: credit card information, name, address, account information for an account on the product management service.

### Example 31

The system of any one of the previous examples comprising a merchant interface module configured to provide a user interface to a merchant to allow the merchant to setup special offers, rebates, or other promotions.

### Example 32

The system of any one of the previous examples comprising a product status information module configured to automatically query a product status service for status information associated with the product.

### Example 33

The system of any one of the previous examples, comprising a special offers module configured to receive special offers from a special offer service.

### Example 34

The system of any one of the previous examples, comprising a manufacturer interface module configured to provide a user interface to a manufacturer to allow the manufacturer to setup warranty registration requirements, rebate requirements, and special offers or other promotions.

### Example 35

The method of any one of the previous examples comprising providing a user interface to a merchant to allow the merchant to setup special offers, rebates, or other promotions.

### Example 36

The method of any one of the previous examples comprising automatically querying a product status service for status information associated with the product.

### Example 37

The method of any one of the previous examples, comprising receiving special offers from a special offer service.

### Example 38

The method of any one of the previous examples, comprising providing a user interface to a manufacturer to allow the manufacturer to setup warranty registration requirements, rebate requirements, and special offers or other promotions.

### Example 39

The machine-readable medium of any one of the previous examples comprising instructions, which when performed by the machine, cause the machine to perform the operations of: providing a user interface to a merchant to allow the merchant to setup special offers, rebates, or other promotions.

### Example 40

The machine-readable medium of any one of the previous examples comprising instructions, which when performed by the machine, cause the machine to perform the operations of: automatically querying a product status service for status information associated with the product.

### Example 41

The machine-readable medium of any one of the previous examples comprising instructions, which when performed by the machine, cause the machine to perform the operations of: receiving special offers from a special offer service.

### Example 42

The machine-readable medium of any one of the previous examples comprising instructions, which when performed by the machine, cause the machine to perform the operations of: providing a user interface to a manufacturer to allow the manufacturer to setup warranty registration requirements, rebate requirements, and special offers or other promotions.

1. A system for providing a product management service, the system comprising:
a point of sale interface module configured to:
receive from a point of sale terminal, over a network, product and consumer information as part of a sale of a product described by the product information;
associate the consumer information with a consumer account; and update the consumer account with the product information responsive to associating the consumer information with a consumer account using a computer processor; and
a warranty registration module configured to send a portion of the product information and a portion of the customer information to a warranty registration service responsive to updating the consumer account with the product information to register the product described by the product information.

2. The system of claim 1, comprising a rebate module configured to determine that a rebate is applicable to the product information and responsive to determining that the rebate is applicable to the product information, sending a portion of the product information and a portion of the customer information to a rebate service to apply for the rebate.

3. The system of claim 2, wherein the rebate module is configured to receive a confirmation from the rebate service that the rebate was processed successfully.

4. The system of claim 3, wherein the rebate module is configured to set a follow-up reminder responsive to receiving the confirmation from the rebate service.

5. The system of claim 4, wherein the rebate module is configured to check a status of the rebate on expiry of the follow-up reminder.

6. The system of claim 5, wherein the rebate module is configured to notify a consumer associated with the consumer account responsive to checking the status of the rebate.

7. The system of claim 1, comprising a consumer interface module configured to provide a consumer with a network accessible user interface, which allows the consumer to view information related to their consumer account.

8. The system of claim 1, wherein the point of sale interface module and the point of sale terminal communicate using a secure protocol.

9. The system of claim 1, wherein the product information comprises at least one of: a universal product code, a stock keeping unit, an item description, a serial number, a lot number, a batch number, and a manufacture date.

10. The system of claim 1, wherein the consumer information includes at least one of: credit card information, name, address, account information for an account on the product management service.

11. A computer processor implemented method of product management comprising:
receiving from a point of sale terminal, over a network, by a product management service, product and consumer information as part of a sale of a product described by the product information;
associating the consumer information with a consumer account by the product management service using the computer processor;
automatically updating the consumer account with the product information responsive to associating the consumer information with a consumer account by the product management service;
sending a portion of the product information and a portion of the customer information by the product management service, to a warranty registration service responsive to updating the consumer account with the product information to register the product described by the product information.

12. The method of claim 11, comprising:
determining that a rebate is applicable to the product information; and
responsive to determining that the rebate is applicable to the product information, sending a portion of the product information and a portion of the customer information to a rebate service to apply for the rebate.

13. The method of claim 12, comprising receiving a confirmation from the rebate service that the rebate was processed successfully.

14. The method of claim 13, comprising setting a follow-up reminder responsive to receiving the confirmation from the rebate service.

15. The method of claim 14, comprising checking a status of the rebate on expiry of the follow-up reminder.

16. The method of claim 15, comprising notifying a consumer associated with the consumer account responsive to checking the status of the rebate.

17. The method of claim 11, comprising providing a consumer with a network accessible user interface, which allows the consumer to view information related to their consumer account.

18. The method of claim 11, wherein receiving from a point of sale terminal, over a network, by a product management service, product and consumer information as part of a sale of a product described by the product information is done using a secure protocol.

19. The method of claim 11, wherein the product information comprises at least one of: a universal product code, a stock keeping unit, an item description, a serial number, a lot number, a batch number, and a manufacture date.

20. The method of claim 11, wherein the consumer information includes at least one of: credit card information, name, address, account information for an account on the product management service.

21. At least one machine readable medium storing instructions which when performed by a machine, cause the machine to perform operations comprising:
receiving from a point of sale terminal, over a network, product and consumer information as part of a sale of a product described by the product information;
associating the consumer information with a consumer account;
updating the consumer account with the product information responsive to associating the consumer information with a consumer account;
sending a portion of the product information and a portion of the customer information to a warranty registration service responsive to updating the consumer account with the product information to register the product described by the product information.

22. The machine-readable medium of claim 21, wherein the instructions which when performed by the machine, cause the machine to perform operations comprising: determining that a rebate is applicable to the product information and responsive to determining that the rebate is applicable to the product information, sending a portion of the product information and a portion of the customer information to a rebate service to apply for the rebate.

23. The machine-readable medium of claim 22, wherein the instructions which when performed by the machine, cause the machine to perform operations comprising: receiving a confirmation from the rebate service that the rebate was processed successfully.

24. The machine-readable medium of claim 23, wherein the instructions which when performed by the machine, cause the machine to perform operations comprising: setting a follow-up reminder responsive to receiving the confirmation from the rebate service.

25. The machine-readable medium of claim 24, wherein the instructions which when performed by the machine, cause the machine to perform operations comprising: checking a status of the rebate on expiry of the follow-up reminder.

26. The machine-readable medium of claim 25, wherein the instructions which when performed by the machine, cause the machine to perform operations comprising: notifying a consumer associated with the consumer account responsive to checking the status of the rebate.

27. The machine-readable medium of claim 21 wherein the instructions which when performed by the machine, cause the machine to perform operations comprising:
providing a consumer with a network accessible user interface, which allows the consumer to view information related to their consumer account.

28. The machine-readable medium of claim 21 wherein the instructions for receiving from a point of sale terminal, over a network, by a product management service, product and consumer information as part of a sale of a product described by the product information include instructions which when performed by the machine, cause the machine to perform operations comprising: communicating with the point of sale terminal using a secure protocol.

29. The machine-readable medium of claim 21, wherein the product information comprises at least one of: a universal product code, a stock keeping unit, an item description, a serial number, a lot number, a batch number, and a manufacture date.

30. The machine-readable medium of claim 21 wherein the consumer information includes at least one of: credit card information, name, address, account information for an account on the product management service.
